(19) United States
(12) Patent Application Publication
(10) Pub. No.: US 2022/0297284 A1
(43) Pub. Date: Sep. 22, 2022

(54) HUMAN BODY SUPPORTING EXOSKELETON DEVICE

(71) Applicant: INNOPHYS Co., LTD, Tokyo (JP)

(72) Inventor: Hiroshi KOBAYASHI, Tokyo (JP)

(73) Assignee: INNOPHYS Co., LTD, Tokyo (JP)

(21) Appl. No.: 17/597,759

(22) PCT Filed: Feb. 17, 2020
(86) PCT No.: PCT/JP2020/005977

§ 371 Date: Jan. 21, 2022

(30) Foreign Application Priority Data
Oct. 31, 2019 (JP) 2019-199071

(51) Int. Cl. B25J 9/00; A61H 3/00

(52) U.S. Cl. CPC B25J 9/0006; A61H 3/008; A61H 2201/1626; A61H 2201/018; A61H 2205/08; A61H 2201/0192

(57) ABSTRACT

A human body supporting exoskeleton device 10 includes base sections 12, an upper body mounting section 18, leg mounting sections 16, a hip belt 14, actuator containers 38, actuators 20, and wires 48, and the upper body mounting section 18 has an upper body frame 18 that consists of one component located in an upper part of the human body supporting exoskeleton device 10, has the actuator containers 38, and is directly connected to the pair of left and right base sections 12, and a ratio of the weight of the human body supporting exoskeleton device 10 to the urging force in a direction in which the human body P is heaved upright is 6 kgf/kg or more.

### TECHNICAL FIELD

The present invention relates to a human body supporting exoskeleton device.

### BACKGROUND ART

An apparatus for supporting human hip exoskeleton as a human body supporting exoskeleton device using artificial muscles is conventionally known (see, for example, Patent Document 1). An apparatus for supporting human hip exoskeleton has a back frame which is tiltably attached to a pair of left and right side parts located on sides of user's hips and which is mounted to the user's back. The apparatus for supporting human hip exoskeleton also has a lower limb frame which is tiltably attached to a pair of left and right side parts and to which thigh plates to be placed in contact with the thighs of the user are fixed. The apparatus for supporting human hip exoskeleton also includes artificial muscles each having one end engaged on the back frame and the other end engaged on the lower limb frame through a wire. Compressed air from inside the compressor or tank is supplied into the artificial muscles through tubes, which causes the artificial muscles to contract. This gives an upright support force to the user's upper body (an urging force in a direction in which the human body is heaved upright), and makes it possible to reduce the load on the hips of the user lifting a heavy object.

Patent Document 1: Japanese Unexamined Patent Application, Publication No. 2013-75078

### DISCLOSURE OF THE INVENTION

### Problems to Be Solved By the Invention

Conventional human body supporting devices have many parts and are therefore heavy in weight. For this reason, even if the urging force in the direction in which the human body is heaved upright is increased, it is difficult to reduce the weight of the human body supporting device the user of the human body supporting device feels, preventing the user from gaining a light fit.

An object of the present invention is to provide a human body supporting exoskeleton device that is made lighter in its weight that the user feels, enables the user to gain a light fit, and is manufactured at lower cost to achieve an affordable price for users.

### Means for Solving the Problems

The present invention relates to a human body supporting exoskeleton device comprising: a pair of left and right base sections that have a first axis corresponding to a leg axis of a human body and a second axis corresponding to a hip axis of the human body, respectively, and have a wire guide at each of the first axis and the second axis; an upper body mounting section that supports the pair of left and right base sections, is located along the upper body of the user at the back of the user, and is tiltably attached to the base sections; leg mounting sections that are mounted on the legs of the user and tiltably attached to the pair of left and right base sections; a hip belt that is connected to the base sections and mounted to a site near the pelvis of the human body; and a pair of left and right actuator containers that are located in the upper body mounting section and contain respective actuators; the actuators contained in the actuator containers; and a pair of left and right wires that are each provided between the corresponding actuator and the corresponding leg mounting section, the left and right wires being guided by the wire guides to pull the leg mounting sections toward the actuators by driving of the actuators so that the upper body mounting section is tilted toward the base sections and the leg mounting sections are tilted toward the base sections, thereby propagating an urging force in a direction in which the human body is heaved upright to the human body via the upper body mounting section and the leg mounting sections, wherein the upper body mounting section has an upper body frame that consists of one component located in an upper part of the human body supporting exoskeleton device, has the actuator containers, and is directly connected to the pair of left and right base sections, and a ratio of weight of the human body supporting exoskeleton device to the urging force in a direction in which the user is heaved upright is 6 kgf/kg or more.

Here, the hip belt preferably comprises: an upper hip belt that connects upper parts of target fixation parts respectively fixed to the pair of left and right base sections and is located above an upper part of a gluteus maximus of the human body, and a lower hip belt that connects lower parts of the target fixation parts and is located adjacent to a lower part of a rear part of the gluteus maximus of the human body.

Further, a length of the upper hip belt is preferably fixed, and a length of the lower hip belt is preferably adjustable. Further, the upper body frame preferably has an inverted V-shape with an apex in the center, and ends of upper body mounting belts to be mounted to left and right shoulders of the human body, respectively, are preferably engaged on the apex.

Further, in an initial state where the human body supporting exoskeleton device is mounted to the human body, settings for the actuators are preferably made so that the upper body mounting section is inclined with respect to the base sections, from the position of the hips of the human body upwardly and away from the back of the human body. Further, the upper body frame is preferably integrally molded with resin. An adjuster capable of adjusting the urging force from the actuators is preferably comprised.

### Effects of the Invention

An object of the present invention is to provide a human body supporting exoskeleton device that is made lighter in its weight that the user feels, enables the user to gain a light fit, and is manufactured at lower cost to achieve an affordable price for users.

### BRIEF DESCRIPTION OF THE DRAWINGS

FIG. 1 is a side view of a human body supporting exoskeleton device according to an embodiment of the present invention;

FIG. 2 is a rear view of the human body supporting exoskeleton device according to the embodiment of the present invention;

FIG. 3 is a rear view of the human body supporting exoskeleton device according to the embodiment of the present invention, from which a cover, a hip belt, and an upper hip belt have been removed;

FIG. 4 is a front view of the human body supporting exoskeleton device according to the embodiment of the present invention, from which the cover, the hip belt, and the upper hip belt have been removed;

FIG. 5 is a side view of the human body supporting exoskeleton device according to the embodiment of the present invention, from which the cover, the hip belt, and the upper hip belt have been removed; and

FIG. 6 is a side view of the human body supporting exoskeleton device according to the embodiment of the present invention, being used by the user.

### PREFERRED MODE FOR CARRYING OUT THE INVENTION

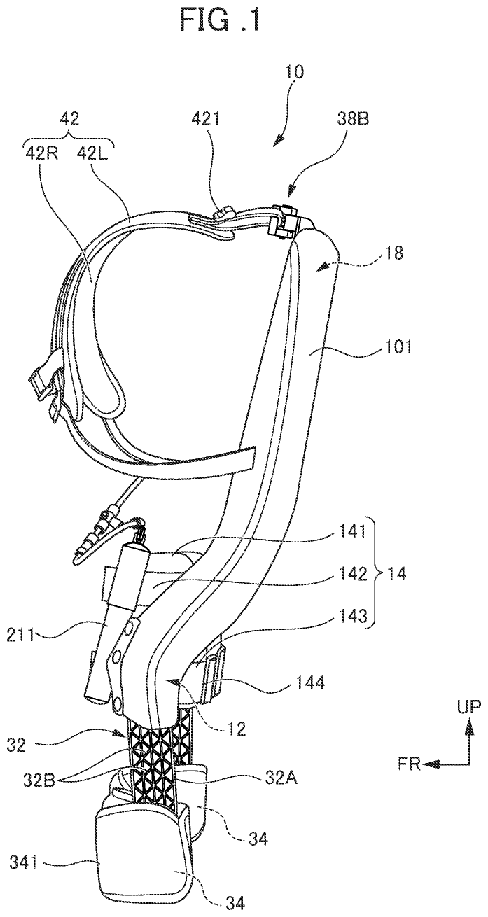

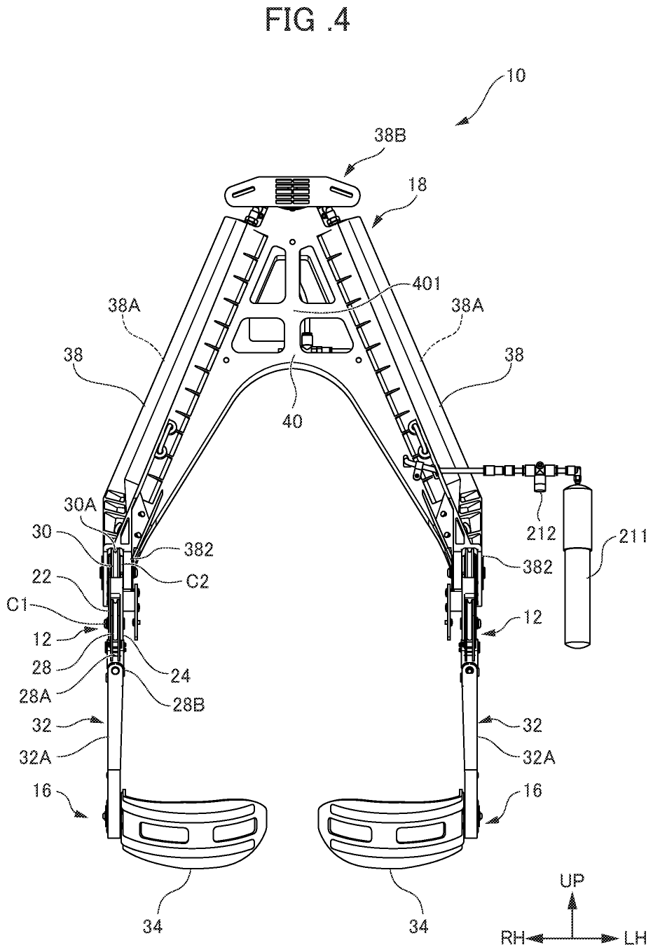

A human body supporting exoskeleton device according to an embodiment of the present invention will be described with reference to FIGS. 1 to 6. In the following description, the front side defined with respect to the front-back direction as seen from the user in an upright position while wearing the human body supporting exoskeleton device is indicated by the arrow FR, the right side and the left side are indicated by the arrows RH and LH, respectively, and the upper side defined with respect to the up-down direction is indicated by the arrow UP. In the following description, simply indicated directions, such as front and back, left and right, and up and down, indicate the front and back, left and right, and up and down as seen from the user in an upright position wearing the human body supporting exoskeleton device.

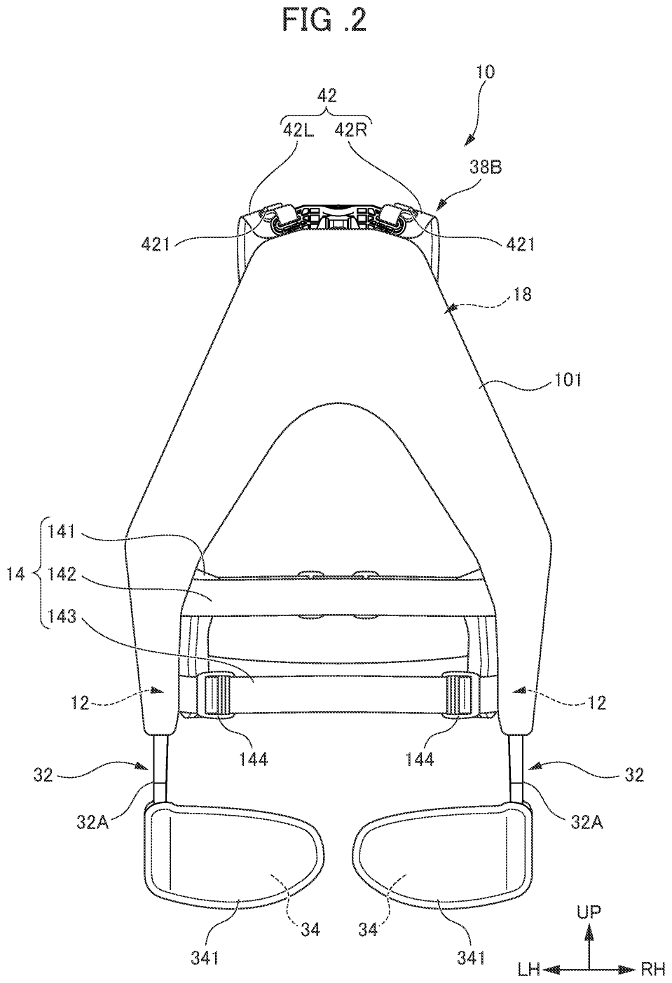

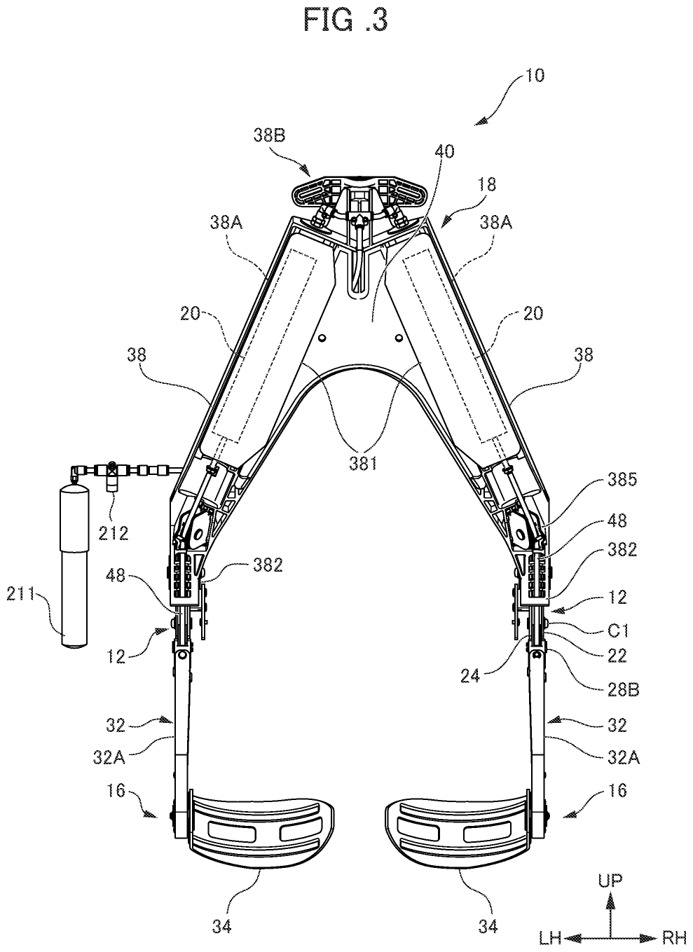

As shown in FIGS. 2 and 3, the human body supporting exoskeleton device 10 includes a pair of left and right base sections 12 that are located on the sides of the user's hips, a hip belt 14 that is attached to the base sections 12 and is mounted around the user's hip (near the pelvis), an upper body frame 18 as an upper body mounting section for supporting the pair of left and right base sections 12, thigh arms 16 as leg mounting sections tiltably attached to the pair of left and right base sections 12, and artificial muscles 20 contained in the upper body frame 18. The base sections 12 and the upper body frame 18 are covered by the cover 101.

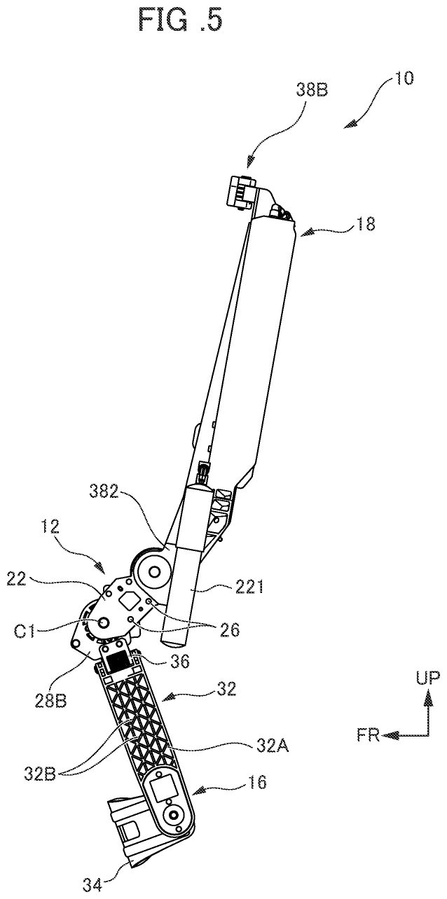

The base sections 12 each include a plate-like outer plate 22 and inner plate 24. The outer plate 22 and the inner plate 24 have an almost the same shape in a side view (when viewed from the right or left side). The outer plate 22 and the inner plate 24 are connected through multiple connection pins 26 (see FIG. 5), or the like and are arranged in parallel at predetermined intervals in the left-right direction.

A first pulley 28 and a second pulley 30 as wire guides are rotatably supported between the outer plate 22 and the inner plate 24. The first pulley 28 is attached below the outer plate 22 and the inner plate 24 so that its rotation axis is oriented in the left-right direction. The rotation axis of the first pulley 28 is a first axis C1 corresponding to a hip joint as the leg axis of the user. In addition, the first pulley 28 has a wire engagement section 28A on which a portion of a wire 48 to be described below is engaged, and a thigh arm 16 to be described below, attached thereto and is provided with a thigh arm attachment section 28B which can be rotated centered about the first axis C1.

The second pulley 30 is attached to the upper part of the outer plate 22 and the inner plate 24 and behind the first pulley 28 so that its rotation axis is oriented in the left-right direction. The rotation axis of the second pulley 30 is a second axis C2 corresponding to a sacroiliac joint as the hip axis of the user. In addition, a guide channel 30A is formed in the outer periphery of the second pulley 30 for guiding a middle portion of the wire 48 defined with respect to the longitudinal direction described below. The parts corresponding to the outer plate 22 and the inner plate 24 that support the second pulley 30 constitute a target connection part to be attached to the upper body frame 18.

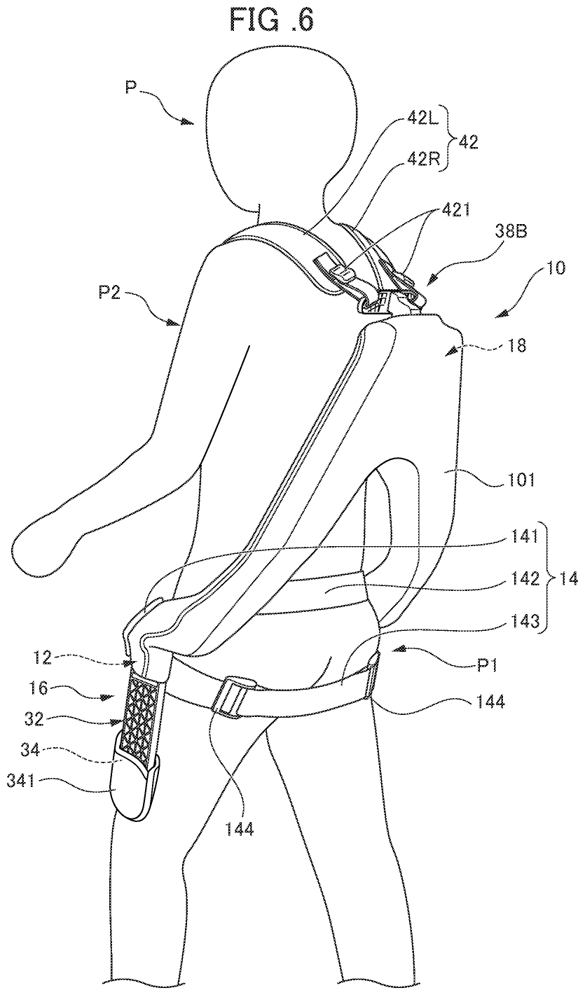

The hip belt 14 has base pads 141 as target fixation parts, an upper hip belt 142, and a lower hip belt 143. Each base pad 141 is fixed to the inner plate 24 of the base section 12 so that it is positioned in parallel with the inner plate 24. Both ends of the upper hip belt 142 are fixed to upper parts of the base pads 141 in such a manner that it is non-adjustable in length. Hence, the upper hip belt 142 connects the upper parts of the base pads 141 together, and the length of the upper hip belt 142 is fixed. The upper hip belt 142, which has a fixed length in this way, is located above the upper part of the gluteus maximus of the user P, as shown in FIG. 6.

Both ends of the lower hip belt 143 are fixed to lower parts of the base pads 141 in such a manner that it is adjustable in length. Hence, the lower hip belt 143 connects the lower parts of the base pads 141 together. A buckle 144 is provided near each of the both ends of the lower hip belt 143, and the length of the lower hip belt 143 is adjustable at the buckles 144. The length of the lower hip belt 143 is designed to be adjusted so that the lower hip belt 143 is located adjacent to, but behind and below the gluteus maximus of the user P.

As shown in FIGS. 2 to 4, each thigh arm 16 has an arm body 32 extending along a thigh of the user P, and a thigh pad 34 attached to the arm body 32 and covered by a cover 341. The arm body 32 has an extension 32A provided with ribs 32B for increasing rigidity, and the base of the extension 32A is attached to the thigh arm attachment section 28B through a hinge 36 that is pivotable about an axis that is oriented approximately in the front-back direction with respect to the thigh arm attachment section 28B. The hinge 36 is configured to be pivotable in the left-right direction, making the thigh arm 16 tiltable in the left-right direction with respect to the base section 12.

Each thigh pad 34 to be mounted on a leg of the user P is fixed to the end of the extension 32A. The thigh pad 34 is formed in a curved shape that follows the front surface of the thigh of the user P. The thigh pad 34 is supported so that it is pivotable at a predetermined angle with respect to the arm body 32 about an axis that is oriented in the left-right direction. This allows the thigh pad 34 to be in proper contact with the front surface of the thigh of the user P.

As shown in FIG. 3, the upper body frame 18 is located in the upper part of the human body supporting exoskeleton device 10, and has an inverted V-shape that is open on the lower side and has an apex in the center in a front view (when viewed from the front side of the user P). The upper body frame 18 includes a pair of artificial muscle attachment sections 38 positioned at a predetermined interval in the left-right direction and each including an artificial muscle container 38A as an actuator container to contain McKibben-type artificial muscles 20 as actuators; and a connection portion 40 which connects the upper portions of the pair of artificial muscle attachment sections 38 in the left-right direction. These consist of one part made of resin integrally molded by injection molding.

The left and right lower ends of the upper body frame 18 have base section attachment parts 382 in a cornered U-shape that is open downward. A target connection part consisting of the outer plate 22 and the inner plate 24 that support the second pulley 30 is located between the base section attachment parts 382. Each base section 12 is supported so that it is pivotable with respect to the base section attachment part 382. In other words, the left and right lower ends of the upper body frame 18 are directly connected to the pair of left and right base sections 12, and the upper body frame 18 is tiltably attached to the base section 12.

The pair of artificial muscle attachment sections 38 are inclined to the right and left sides of the user P, respectively, from the upper side toward the lower side in a front view. The artificial muscle attachment sections 38 each have a channel (not shown in the drawing) having a cornered U-shaped cross section and an opening on the rear side, and the portions where the channels are formed constitute the artificial muscle containers 38A, and the artificial muscles 20 are contained in the channels. The rear opening is closed by a lid 381. The connection portion 40 has a cross-shaped rib 401 and has high rigidity to connect the pair of artificial muscle attachment sections 38 together.

Each artificial muscle 20 is composed of an elastic tube (not shown in the drawings) formed in a tubular shape using an elastic material such as rubber, and a cylindrical mesh sleeve (not shown in the drawings) covering the elastic tube (not shown in the drawings), in such a manner that the mesh sleeve covers the elastic tube and both ends are caulked.

The elastic tube (not shown in the drawings) has a space to be supplied with a gas (air), and the inside of the elastic tube (not shown in the drawings) is configured to be supplied with air via a pump 211 connected through a tubular member. The tubular member is provided with an adjustment valve 212 that can adjust the amount of air supplied to the elastic tube, and the adjustment valve 212 is used to adjust the amount of air as appropriate for adjusting urging force, allowing the urging force by the artificial muscles 20 to be adjusted as appropriate depending on the situation, such as use by a senior, a woman, or other users who has lower general muscle strength, or use by a man or other users who has higher general muscle strength.

The mesh sleeve (not shown in the drawings) is formed, for example, by weaving wires of high tensile fibers or the like having small elasticity. When air is supplied into the elastic tube (not shown in the drawings) disposed in the mesh sleeve and the elastic tube expands, the dimension in the direction perpendicular to the length direction of the mesh sleeve increases and the dimension in the length direction of the mesh sleeve decreases. This configuration shortens the lengths of the artificial muscles 20 (causing the artificial muscles 20 to contract) and generate the force to support the hips and arms described below.

One end of each artificial muscle 20 is fixed to the artificial muscle attachment sections 38, and the other end of the artificial muscle 20 has a wire 48 engaged on it. Each wire 48 is derived from the lower end of the upper body frame 18, and is looped over the rear side of the pulley 385 located at the lower end of the upper body frame 18, the rear side of the second pulley 30, and the rear side of the first pulley 28 in this order and is guided by them, and the other end of the wire 48 is engaged on a wire engagement section 28A of the first pulley 28. Driving the artificial muscles 20 pulls the thigh arms 16 toward the artificial muscles 20, thereby tilting the upper body frame 18 with respect to the base section 12 and the thigh arms 16 with respect to the base section 12 and thus propagating the urging force in the direction in which the user P is heaved upright to the user P via the upper body frame 18 and the thigh arms 16.

At the position of the central apex of the inverted V-shaped upper body frame 18, an upper body mounting belt attachment portion 38B to which ends of upper body mounting belts 42 to be attached to the upper body of the user P are attached is fixed to the upper body frame 18. As shown in FIG. 6 and other drawings, the upper body mounting belts 42 include a right mounting belt 42R configured to be attached to the right shoulder of the user P, and a left mounting belt 42L configured to be attached to the left shoulder of the user P. The lengths of the right mounting belt 42R and the left mounting belt 42L are adjustable by the respective buckles 421. Of the upper body frame 18, the right mounting belt 42R is mounted to the right shoulder of the user P, and the left mounting belt 42L is mounted to the left shoulder of the user P. The part of the upper body mounting belt attachment portion 38B is positioned away from the back of the user P and is located along the upper body of the user P at the back of the user P. In other words, in the initial state where the user P wears the human body supporting exoskeleton device 10, as shown in FIG. 6, settings for the artificial muscles 20 are made so that the upper body frame 18 is inclined from the position of the hips of the user P upwardly and away from the back of the user P. In this state, even if the first axis C1 and the second axis C2 are not perfectly aligned with the leg axis and the hip axis (hip joint and sacroiliac joint) of the user P, misalignment with respect to the user P can be suppressed when the human body supporting exoskeleton device 10 is assisting the movement of the user P.

The weight of the aforementioned human body supporting exoskeleton device 10 is 4.25 kg or less, specifically, about 3.8 kg in this embodiment. In addition, the urging force (assisting force) by the human body supporting exoskeleton device 10 in the direction in which the human body is heaved upright is 25.5 kgf (100 Nm) or more. Accordingly, the ratio of the weight of the human body supporting exoskeleton device to the urging force in the direction in which the human body is heaved upright (hereinafter referred to as the “assist ratio”) is 6 kgf/kg or more.

The support of the user P by the aforementioned human body supporting exoskeleton device 10 will now be described. As shown in FIG. 6, in this embodiment, the hip belt 14, the upper body mounting belts 42, and the thigh arms 16 are mounted to the hips P1, the upper body P2, and the thighs of the user P, respectively, so that the human body supporting exoskeleton device 10 is mounted to the user P.

More specifically, as shown in FIG. 6, the upper hip belt 142 of the hip belt 14 having a fixed length is located above the upper part of the gluteus maximus of the user P, that is, in a position corresponding to the position of the belt for the trousers. With reference to this position, the length of the lower hip belt 143 of the hip belt 14 is adjusted so that the lower hip belt 143 is located adjacent to the lower part of the rear part of the gluteus maximus of the user P. As a result, as shown in FIG. 6, the gluteus maximus is sandwiched between the upper hip belt 142 and the lower hip belt 143 from above and below, so that the human body supporting exoskeleton device 10 is less likely to slip out of place with respect to the human body of the user P even when the user P moves. In this state, the upper body mounting belts 42 and the thigh arms 16 are mounted to the hips P1, the upper body P2, and the thighs of the user P, respectively, and the human body supporting exoskeleton device 10 is mounted to the user P.

When the user P lifts a heavy object placed on the floor, the contraction of the artificial muscles 20 pulls the wires 48 toward the artificial muscles 20, which causes the upper body frame 18 to pivot with respect to the base section 12, generating a support force in the direction in which the upper body P2 of the user P leaning forward is heaved upright. In addition, the thigh arms 16 are made pivot with respect to the base section 12 to generate a support force in the direction in which the bent legs of the user P are straightened. This reduces the load generated on the hips P1 of the user P when the user P lifts a heavy object placed on the floor.

According to the embodiment described above, the following advantageous effects can be achieved. In this embodiment, the upper body frame 18 as an upper body mounting section is an upper body frame 18 consisting of a single component located in the upper part of the human body supporting exoskeleton device 10, and includes an upper body frame 18 having actuator containers 38 and directly connected to the pair of left and right base sections 12, and the ratio of the weight of the human body supporting exoskeleton device 10 to the urging force in the direction in which the user P is heaved upright (assist ratio) is 6 kgf/kg or more.

This configuration not only reduces the total weight of the human body supporting exoskeleton device 10, but also reduces the weight of the upper body frame 18, which is located in the upper part of the human body supporting exoskeleton device 10, thereby allowing the center of gravity of the overall human body supporting exoskeleton device 10 to be located in a lower position. This makes it possible to reduce the weight that the user P feels when wearing the human body supporting exoskeleton device 10. Besides, since fewer parts are used, the manufacturing cost for the human body supporting exoskeleton device 10 is reduced and the price of the human body supporting exoskeleton device 10 can be made affordable for the user P.

Further, the total weight of the human body supporting exoskeleton device 10 is reduced, while the urging force in the direction in which the user P is heaved upright is strong, and the ratio of the weight of the human body supporting exoskeleton device 10 with respect to the urging force in the direction in which the user P is heaved upright is 6 kgf/kg or more, so that the urging force as an assisting force is exerted from the lightweight human body supporting exoskeleton device 10, and the user P can feel lighter assistance by the human body supporting exoskeleton device 10. As a result, compared with conventional human body supporting exoskeleton devices, the user P wearing and working with the device feels more lightness and the human body supporting exoskeleton device 10 can be used more comfortably.

In addition, in this embodiment, the hip belt 14 comprises: an upper hip belt 142 that connects the upper parts of the base pads 141 as target fixation parts respectively fixed to the pair of left and right base sections 12, and is located above the upper part of the gluteus maximus of the user P, and a lower hip belt 143 that connects the lower parts of the base pads 141 and is located adjacent to the lower part of the rear part of the gluteus maximus of the user P.

With this configuration, the upper hip belt 142 is stably located in a position corresponding to the position of the belt for the trousers of the user P. The lower hip belt 143 is stably located adjacent to the lower part of the rear part of the gluteus maximus of the user P. As a result, as shown in FIG. 6, the gluteus maximus is sandwiched between the upper hip belt 142 and the lower hip belt 143 from above and below. Hence, the user P is like sitting between the upper hip belt 142 and the lower hip belt 143, so that the upper hip belt 142 and the lower hip belt 143 are less likely to slip out of place with respect to the user P, and the user P can stably use the assistance by the human body supporting exoskeleton device 10. Besides, the user P feels less heavy with the human body supporting exoskeleton device 10 due to a displacement in the weight balance caused by a misalignment.

The length of the upper hip belt 142 is fixed, and the length of the lower hip belt 143 is adjustable. With this configuration, when the user P wears the human body supporting exoskeleton device 10, while the upper hip belt 142 with a fixed length is stably placed in a position corresponding to the position of the belt for the trousers of the user P, the length of the lower hip belt 143 can be adjusted to fit in the lower part of the rear part of the gluteus maximus. Consequently, the hip belt 14 can be mounted to a site near the pelvis of the human body of the user P in the positional relationship where the gluteus maximus is sandwiched from above and below. In other words, the upper hip belt 142 and the lower hip belt 143 can be accurately located at appropriate positions (sites) of the user P. This leads to suppression of feeling heavy with the human body supporting exoskeleton device 10 or feeling uncomfortable during assistance because of an inappropriate position of the human body supporting exoskeleton device 10 with respect to the user P.

In addition, the upper body frame 18 has an inverted V-shape having an apex in the center, and ends of the upper body mounting belts 42 mounted to the respective left and right shoulders of the human body of the user P are engaged on the apex. This eliminates the need for separately providing a component extending from the upper body frame 18 for engaging the ends of the upper body mounting belts 42 thereon, and connecting it to the upper body frame 18, thereby allowing the parts count and the weight of the upper part of the human body supporting exoskeleton device 10 to be reduced.

The upper body frame 18 is integrally molded with resin. This configuration ensures a reduction in the total weight of the human body supporting exoskeleton device 10.

The present invention may be implemented in various modes within the scope of the claims, without being limited to the embodiments described above. For example, the configuration of each part of the human body supporting exoskeleton device is not limited to the configuration of each part of the human body supporting exoskeleton device 10. In other words, the configurations of the base sections, upper body mounting section, leg mounting sections, hip belt, actuator, actuator containers, wires, and the like are not limited to the configurations of the base sections 12, upper body frame 18, thigh arms 16, hip belt 14, artificial muscles 20, artificial muscle attachment section 38, wires 48, and the like of this embodiment.

### EXPLANATION OF REFERENCE NUMERALS

10 Human body supporting exoskeleton device
12 Base section
14 Hip belt
16 Thigh arm (leg mounting section)
18 Upper body frame (upper body mounting section)
20 Artificial muscle (actuator)
28 First pulley (wire guide)
30 Second pulley (wire guide)
38 Artificial muscle attachment section (actuator container)
48 Wire
141 Base pad (target fixation part)
142 Upper hip belt
143 Lower hip belt
C1 First Axis
C2 Second Axis

1. A human body supporting exoskeleton device comprising:
a pair of left and right base sections that have a first axis corresponding to a leg axis of a human body and a second axis corresponding to a hip axis of the human body, respectively, and have a wire guide at each of the first axis and the second axis;
an upper body mounting section that supports the pair of left and right base sections, is located along the upper body of the user at a back of the user, and is tiltably attached to the base sections;
leg mounting sections that are mounted on legs of the user and tiltably attached to the pair of left and right base sections;
a hip belt that is connected to the base sections and mounted to a site near a pelvis of the human body;
a pair of left and right actuator containers that are located in the upper body mounting section and contain respective actuators;
the actuators contained in the actuator containers; and
a pair of left and right wires that are each provided between the corresponding actuator and the corresponding leg mounting section, the left and right wires being guided by the wire guides to pull the leg mounting sections toward the actuators by driving of the actuators so that the upper body mounting section is tilted toward the base sections and the leg mounting sections are tilted toward the base sections, thereby propagating an urging force in a direction in which the human body is heaved upright to the human body via the upper body mounting section and the leg mounting sections, wherein
the upper body mounting section has an upper body frame that includes one component located in an upper part of the human body supporting exoskeleton device, has the actuator containers, and is directly connected to the pair of left and right base sections, and
a ratio of weight of the human body supporting exoskeleton device to the urging force in a direction in which the user is heaved upright is 6 kgf/kg or more.

2. The human body supporting exoskeleton device according to claim 1, wherein
the hip belt comprises:
an upper hip belt that connects upper parts of target fixation parts respectively fixed to the pair of left and right base sections and is located above an upper part of a gluteus maximus of the human body, and
a lower hip belt that connects lower parts of the target fixation parts and is located adjacent to a lower part of a rear part of the gluteus maximus of the human body.

3. The human body supporting exoskeleton device according to claim 2, wherein
a length of the upper hip belt is fixed, and
a length of the lower hip belt is adjustable.

4. The human body supporting exoskeleton device according to claim 1, wherein
the upper body frame has an inverted V-shape with an apex in the center, and
ends of upper body mounting belts to be mounted to left and right shoulders of the human body, respectively, are engaged on the apex.

5. The human body supporting exoskeleton device according to claim 2, wherein in an initial state where the human body supporting exoskeleton device is mounted to the human body, settings for the actuators are made so that the upper body mounting section is inclined with respect to the base sections, from a position of a hip of the human body upwardly and away from the back of the human body.

6. The human body supporting exoskeleton device according to claim 1, wherein the upper body frame is integrally molded with resin.

7. The human body supporting exoskeleton device according to claim 1, further comprising an adjuster capable of adjusting the urging force from the actuators.
